(19) United States
(12) Patent Application Publication
(10) Pub. No.: US 2015/0157125 A1
(43) Pub. Date: Jun. 11, 2015

(54) MODULAR HUMANOID SHELF SYSTEM

(71) Applicant: Adil VEZIROV, Philadelphia, PA (US)

(72) Inventor: Adil VEZIROV, Philadelphia, PA (US)

(21) Appl. No.: 14/562,274

(22) Filed: Dec. 5, 2014

Related U.S. Application Data
(60) Provisional application No. 61/912,966, filed on Dec. 6, 2013.

(51) Int. Cl. A47B 47/00; G06Q 30/06

(52) U.S. Cl. CPC A47B 47/0075; A47B 47/0091; G06Q 30/0621; G06Q 30/0641

(57) ABSTRACT

A modular shelving system comprising at least 4 common elements, a head a torso, a pair of arms and a pair of legs, capable of being configured in various positions.

### FIELD OF THE INVENTION

This application claims priority to U.S. Provisional patent application No. 61/912,966 filed Dec. 6, 2013, which is incorporated herein by reference.

Presently disclosed embodiments are related to shelving systems, in particular to modular shelving systems comprising a pre-determined set of modular components that can be arranged into numerous designs that provides for a stable and modifiable shelving system.

### BACKGROUND

Shelving systems are well known in the art. Many are simple systems comprising two sides and shelves disposed between thereof. However, such systems provide little in the way of modification and result in static square or rectangular shaped shelving systems.

Modular shelving systems are also well known in the art, but are typically confined to square or rectangular shapes that do not lend themselves to total freedom to modify the shape of the shelving system or to customize components within the system. These systems do not allow for modification of shape or design to fit the individual user or the space for the system.

No system provides for a modular system of predetermined components that further comprises humanoid forms, wherein a predetermined set of standard components allows for modification and variation of the system within such set of standard components.

### SUMMARY

Embodiments of the present disclosure relate to modular shelving systems having a generally humanoid form. In particular, the modular shelving system comprises a predetermined set of standard components comprising a head, a body, a pair of legs or arms, and four hands or feet, which are then able to be modified into numerous forms that provide for a stable, but modifiable shelving system.

Further embodiments comprise at least five modular components, suitable for being situated into a shelving system, comprising a head, a body, four thigh or upper arm components, four lower leg or lower arm components, and four hands and feet.

Further embodiments comprise at least six modular components, suitable for being situated into a shelving system, comprising a head, a body, four thigh or upper arm components, four lower leg or lower arm components, four hands and feet, and a skirt, wherein the thigh or upper arm components are identical and the four lower leg or lower arm components are identical, and the four hands and feet components are identical.

Further embodiments comprise at least six modular components, suitable for being situated into a shelving system, wherein the thigh and upper arm components are different, and the lower leg and lower arm components are different, but wherein the total length of the arm and leg components remains identical.

An arm or leg 4 component is capable of being used as 1, 2, 3, 4, 5, or even more pieces as desired by the user. The standard feature is that no matter the number of pieces, the total dimensions remain about the same as if the arm or leg 4 was a single piece. However, by making cuts into the single piece, the arm/leg 4 feature can be transformed into multiple pieces, and add the appearance of a knee, elbow, hip, shoulder, etc., to add to the humanoid shelving system.

A modular shelf system comprising seven standard elements, a head, a body, an upper arm, a pair of lower arms, an upper leg, a pair of lower legs, and four hand/foot elements, wherein the head is attached to the upper arm element, and the upper arm element is further connected to the body element; wherein on the opposite side of the body element, the upper leg element is secured to the bottom of the body element; wherein the lower arms are attached to each end of the upper arm and the lower legs are attached to each end of the upper leg.

A modular shelf system comprising a head, a body, an arm element, a leg element, two hand elements, and two foot elements, wherein said arm and leg components can be configured to and secured to the head and body elements, and said hand and foot elements configured to said arm and leg elements wherein said system defines a modular system having a humanoid form.

A modular shelf system comprising a head, a body, an arm element, a leg element, two hand elements, and two foot elements, wherein said arm and leg components can be configured to and secured to the head and body elements, and said hand and foot elements configured to said arm and leg elements wherein said system defines a modular system having a humanoid form; wherein said head element comprises five components, a top, two sides, and a bottom, and a hat element, being slightly longer than the top element, and secured to the top element, wherein the features create an open quadrilateral shaped feature; wherein said body element comprises four components, a top, two sides, and a bottom that are arranged to create a quadrilateral shaped feature that has dimensions larger than the head element.

A modular shelf system comprising 23 elements, comprising five head elements, four torso elements, five arm elements, five leg elements, and four equal hand/foot elements; wherein said head elements are arranged in a generally rectangular shape using four of the elements and the fifth element being attached to one side of the rectangular shape; wherein the four torso elements are arranged in a generally rectangular shape, and wherein said arm and leg elements can be arranged in any number of arrangements when attached to said head and torso elements to create a humanoid like shelf system, and wherein each of the four hand or foot elements are attached to at least one arm or leg element.

A method of selecting a modular shelf system comprising: a computer implemented medium comprising a display and tool mechanism for selecting elements; displaying a selection of head, body, arm, leg, hand and foot elements; selecting a head element, a body element, five arm elements, five leg elements, two hand elements, and two feet elements; organizing said elements wherein each of said elements are secured to at least one other element; saving the organization of said elements through said computer implemented medium; and paying for said modular shelf system having said selected and organized elements.

A shelf system comprising: a computer implemented medium providing for selection among a head element, a torso element, two arm elements, and two leg elements; wherein said computer implemented medium provides a display to display, selected, and arrange said head, torso, arm and leg elements together into a pattern whereby each of the elements are secured to one another; and wherein said displayed, selected, and arranged pattern can then be ordered wherein said elements are pre-cut and/or assembled for installation.

A method of selecting a modular shelf system comprising: a computer implemented medium and a mechanism for selecting elements; selecting a head element, a torso element, arm elements, leg elements, and foot and hand elements; organizing said elements wherein each of said elements are secured to one another; saving the organization of said elements through said computer implemented medium; and paying for said modular shelf system having said selected and organized elements.

A modular shelf system comprising 19 standard elements, comprising five head elements, four torso elements, five arm elements and five leg elements; wherein said arm and leg elements can be arranged in any number of arrangements of said five components when attached to said head and torso elements.

### BRIEF DESCRIPTION OF THE DRAWINGS

FIG. 1 a depiction of a modular shelving system comprising a humanoid form.

FIGS. 2A, 2B, 2C, and 2D depict an elements of an embodiment of a modular shelving system.

FIGS. 3A, 3B, 3C, and 3D depict embodiments of a modular shelving system wherein the leg and arm components are depicted in several pieces instead of a single piece.

FIG. 4 depicts an embodiment of the invention described herein.

FIG. 5 depicts an embodiment of the invention described herein.

FIG. 6 depicts an embodiment of the invention described herein.

FIG. 7 depicts an embodiment of the invention described herein.

FIG. 8 depicts an embodiment of the invention described herein.

### DETAILED DESCRIPTION OF PREFERRED EMBODIMENTS

All references cited herein are hereby incorporated by reference in their entirety.

As used herein, the term “about” is intended to encompass a range of values ±10% of the specified value(s). For example, the phrase “about 20” is intended to encompass ±10% of 20, i.e. from 18 to 22, inclusive.

As used herein, the term “modular” means the ability to take pre-determined or pre-formed individual components and organize them together into one of a number of different configurations.

The concept of a humanoid modular shelving system comprises a set of decorative, yet highly functional humanoid shelving components that when combined, take on the form of humanoid/robot. The arms, legs, body, head, and foot/hand components function as sections of shelving on which items could be set and/or displayed. The shelving system can be produced from wood, plastic, metal, or other suitable natural or synthetic materials as is known to one of ordinary skill in the art.

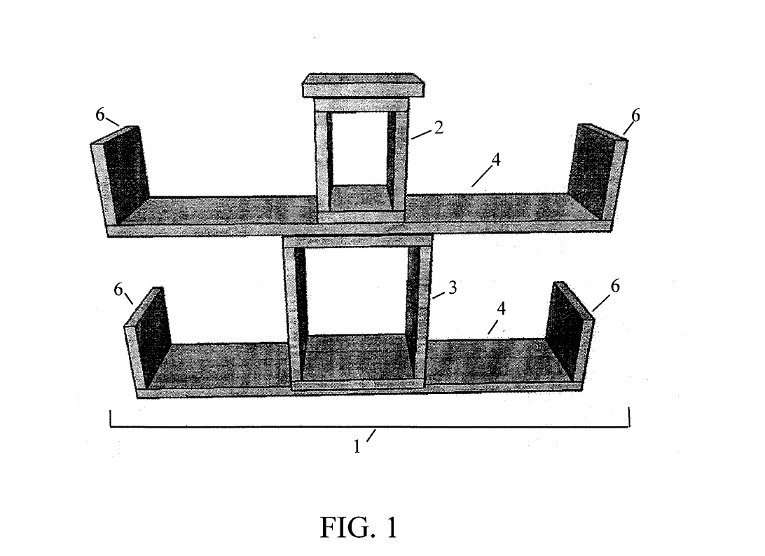

In view of FIG. 1, a first embodiment of a modular humanoid shelf system comprises a predetermined set of five components, each having a particular length, width, and height, so that any particular configuration of the components would measure anywhere from 24″×3½″×32″ to 36″×5½″×28″. The components include a head 2, and body 3, two components that function as an arm or leg 4, and four components that function as a foot or hand 6. The arm and leg 4 have the same dimensions and are thus interchangeable. Similarly, the feet and hands 6 having the same dimensions and are thus interchangeable.

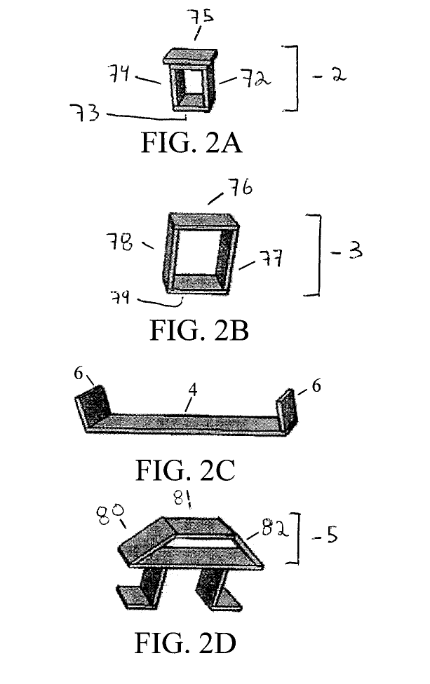

In particular, FIG. 2 identifies embodiments of certain modular components. In particular, the components can be combined to create a humanoid form. FIG. 2A provides a depiction of a head element. The head 2 includes five pieces that form a quadrilateral shape such as a square or a rectangle. The sides of the head 71 and 72 are affixed to the top and bottom 73 and 74 of the head to create the quadrilateral shape, leaving an open space in the middle. A hat 75 is further affixed to the top 74 of the head. In other embodiments, the hat 75 may be affixed to any side of the head 2 to allow for artistic freedom.

FIG. 2B provides a depiction of a body 3 element. The body 3 is slightly larger than the head 2, and contains four pieces that again make a quadrilateral shape such as a square or a rectangle. The two sides 77 and 78 are connected to the top 76 and bottom 79. This creates a quadrilateral shape feature with an opening in the body 3. The head 2 and body 3 can be secured together, or a part of the arms 4 can be secured between them. The leg 4 feature is then secured to some portion of the body 3 to create the humanoid shelving system.

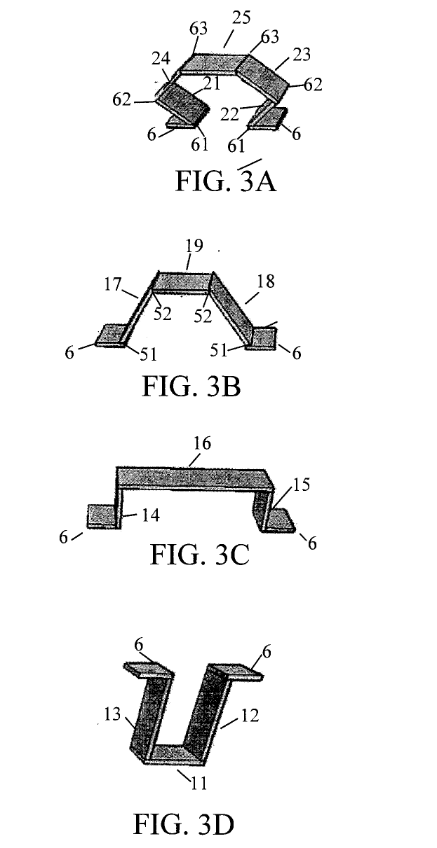

FIG. 2C provides a depiction of one embodiment of an arm or leg 4 component. The shelving system comprises two arm or leg components 4. The arm or leg component 4 has the same total dimensions whether used as an arm or a leg. Finally, FIG. 2C also depicts hand or foot 6 components. FIGS. 3A-3D depict variations of the arm/leg 4 features that provide that the single arm/leg 4 feature can be divided from a single piece of material into two, three, four, five, or more components, that allow for artistic freedom and modular capabilities with regard to the arms or legs of the shelving system. Because the system is modular, the orientation of all components of the arms may be different than the orientation of the leg components, or they may be the same in other embodiments.

In the shelving system, four hand or foot 6 components are added to create the humanoid form. In certain embodiments, a skirt 5 feature may define a female form as see in FIG. 2D.

The shelving system, in certain embodiments, therefore comprises a set of standard components that can then be organized and arranged to create the modifiable humanoid forms. In particular, the arm/leg components are modifiable by making the leg or arm components into one or more elements, as seen in view of FIGS. 3A-3D. The features are described as a leg, but in each case can also be considered an arm component. Beginning with 3D, for example, it is depicted that a leg having a single cut of the leg component, which has resulted in two components, a left leg 13 and a right leg 12 that are half the size of the original a leg component 4. By putting the left leg 13 and right leg 12 together, they combine to become the original single piece leg component 4. The feature 11, refers generically to a portion of either the head 2 or the body 3 to which the leg/arm components could be attached. Accordingly, a modification includes a single cut, in the middle of either the arm or leg component, thus making independent right 12 and left 13 legs that can be individually arranged.

In comparison, FIG. 3C, two cuts were made thus creating three components the left leg 14, the right leg 15, and the upper leg 16. Indeed, in a preferred embodiment, a standard set of the modular shelf system comprises the leg or arm component 4 that is pre-cut into these three pieces the left leg 14, the right 15, and the upper leg 16. Similarly an identical three cuts can be made with regard to the arm component.

Accordingly, there are two pairs of the three leg components 14, 15, and 16, one can be used as a set of legs and the other pair used as the arms. By having these three components, the leg and arm features are highly modifiable, thus creating the modular shelving system. Included with such modular shelving system, and to ensure that such system is modular, but also stable, are components to allow for each of the leg components 14, 15, and 16, to be attached to one another at right angles, at 45 degree angles, or other angles as desired by the user. Indeed, even with the components 14, 15, and 16 the feature can be combined to create a straight leg or arm as depicted in FIG. 1 as the arm or leg 4.

Therefore, the shelves are modular, enabling them to be separated from one another and used interchangeably. When configured as desired, the modular components would be attached to one another utilizing threaded fasteners, nails, fastening clips, brackets, notches, lock and key, dove tail, adhesives, dowel and holes, brackets, clamps, or other securing means known in the art, or combinations thereof. The arms or legs would extend from the torso or head at various angles and configurations. The 180°, 90°, 45°, or other angles as desired at the shoulder and elbow, hip and knee locations, create options to form a unique posture or shape of the arm or legs.

The shelf system is suitable for storage of typical items, such as pictures, books, trinkets, and the like. In certain cases, a TV can be utilized and situated within the body 3, and further components can be stored in the head, legs, arms, and on a hand or foot. A shelf system can support at least 50 pounds of weight in the body 3 and head 2 and at least 20 pounds on a foot or leg, and at least 5 pounds on a hand, and at least 100 pounds on a foot. When the system is further combined with securing means to the wall, additional support is achieved and the shelf system can support greater weights. Indeed, the particular components that are utilized to secure and support the system is indicative of the total amount of weight that can be supported by the elements.

FIG. 3B further defines an embodiment wherein two cuts are made to create modular components. In particular, as compared to FIG. 3C, wherein perpendicular cuts were made, in FIG. 3B, angular cuts are made, thus allowing the leg/arm feature to have angled orientation at what can be considered the ankle 51, and at the hip 52. This provides that the left leg 17 and the right leg 18 are angled, and attached to a hip section 19. Again, each of these sections can be attached to one another with any mechanism as known of one of skill in the art.

Furthermore, the features do not need to be symmetrical on each side of the body. One arm or leg can be up, while the other is positioned down. This can be achieved by placing features at an angle on a floor surface, or by attaching the components of the shelving system to a wall surface, and thus allows for unique modular formations having a humanoid form. Indeed, by securing the components to a vertical wall surface, additional orientations can be achieved can be achieved through use of the various components. The components can be secured the wall with threaded fasteners, nails, fastening clips, brackets notches, lock and key, dove tail, adhesives, dowel and holes, brackets, clamps, or other securing means known in the art, or combinations thereof

FIG. 3A provides a further embodiment of the shelving system, wherein the leg portions are split into a total of five pieces. Features 21, 22, 23, 24, and 25 depict the left lower leg 21, the right lower leg 22, the left thigh 24, the right thigh 23, and the hip section 25. Further depicted are angled cuts at points 61, 62, and 63 that allow for the thigh features 23 and 24 to be angled away from the hip 25. However, the pieces 21 and 24 could just as easily be rotated 180 degrees each, wherein the angled cut portions are mated together, and result in straight legs, such as is otherwise depicted in FIG. 3D, by replacing feature 11 with feature 25. Accordingly, in preferred embodiments, the arm/leg feature is provided in five pieces, wherein pieces 21 and 22 are identical, 23 and 24 are identical and the hip piece 25. Similarly, these can be arm components.

A particularly preferred embodiment comprises the components of an arm/leg as depicted in FIG. 3A wherein each the legs comprise five elements, 21-25, and the arms also comprise five elements 21-25. Furthermore, four hand/feet elements 6 are utilized. By having the leg component comprise five features, any number of variations and designs can be created by simply arranging and affixing the elements together. For example, FIG. 3A can be created as depicted. However, FIGS. 3B, 3C, and 3D can also be created, simply by affixing two of the components together such that, for example 21 and 24 are combined to create feature 17 in FIG. 3B. Similarly, 23, 24, and 25 can be combined to make feature 16 in FIG. 3C. Accordingly, by having five components, the shelving system can be customized in many different arrangements.

Once a modular form is created, a user secures each of the various components to one another with fastening means and alternatively or additionally, securing such components to a wall surface, to create the modular shelving system. These modular shelving systems can be stacked on top of one another or used as individual units. They can be mounted on the wall, individually or in groups, in multiple orientations i.e. right-side up, sideways, upside-down, in order to maximize the design feature or storage capacity of the system.

The inner sections of the torso 3 and heads 2 are hollow to create enclosed storage and/or display areas. The inside the head 2 and torso 3 hollow cavity space are made to be sufficiently large to fit standard photographic sizes such as 4″×6″, 8×10″, 3″×3″, 5″×7″ in order to personalize each unit. The potential exists for varying the production in ways which could make them more appealing to a wider range of end users. This could include producing units of various colors and sizes. However, the exact dimensions can be modified to create larger or smaller shelf systems to fit any number of spaces. In certain embodiments the dimensions are about 3-5″ larger than the dimensions of the photograph size, though dimensions of 34″, 36″, 48″ and larger are envisioned for posters and other large size applications.

An appealing features of the modular shelf system is the lightweight nature of the system and ease of handling, ease of assembly, ease of use, configuration versatility, novelty decorative and artistic appeal, storage function, and facilitation of decorative item display. The set of shelves performs a practical function of a shelf in a novel and artistic manner. The convenience associated with this product would first be realized through its ease of handling. The lightweight construction of this product would allow it to be easily carried and handled for use. It would be easy to install and use. The various possibilities of robotic/humanoid forms in totality, or interchanged with others, would create eye-catching interest on a wall.

The modular shelf system can be produced easily using conventional and readily available materials and manufacturing processes. No new production technology would be required. A typical system is made from lumber, metal, plastic, stone, or other manufactured or natural materials. These materials are easily cut and shaped using conventional equipment and techniques and then machined to smooth edges.

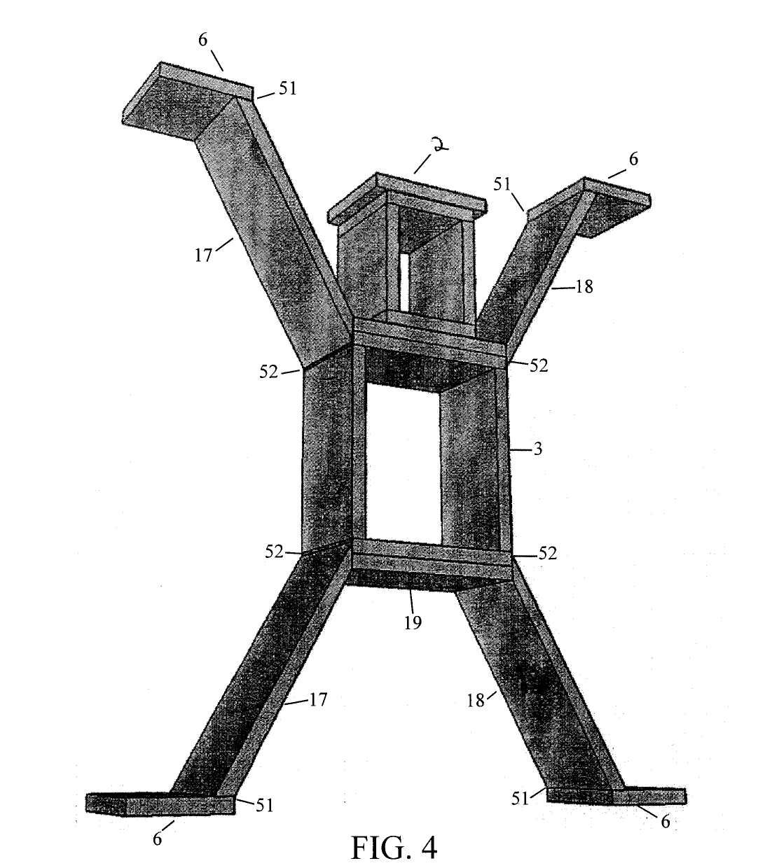

FIG. 4 depicts a particular orientation of an embodiment of the invention wherein the arm and leg pieces are cut at an angle 51 and 52 on each end, allowing for the arms and legs to extend away from the body 3 and head 2. In this case, the standard components of the head 2 the body 3 are attached to the shoulder and hip piece 19. Then each of the two arms and two legs 17 and 18 are attached using know attachment means, and then the hands and legs 6 are further attached using known attachment means. FIG. 4 can be further created with five arm/leg components simply by attaching two of the five components together to create elements 17 or 18.

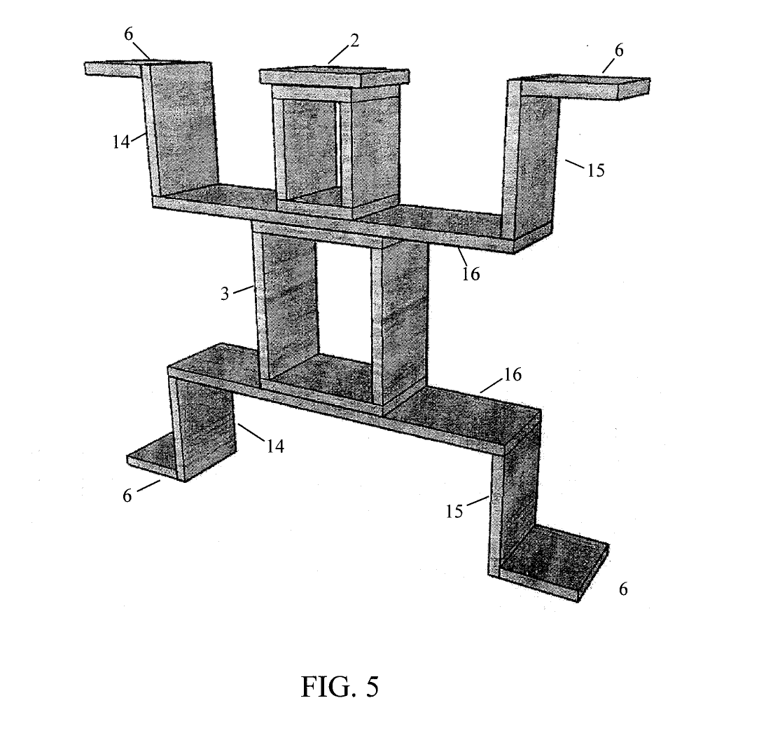

FIG. 5 provides a further view of an embodiment wherein the hip or shoulder sections 16 extend away from the body 3 but parallel to the ground, and then attach arm and leg sections 14 and 15 perpendicular to the ground, and finally attached the hand and foot sections 6 parallel to the ground. As with FIG. 4, such attachments are made by attachment means as known to one of skill in then art. FIG. 5 can be created from five arm/leg elements by combining three elements together to create feature 16.

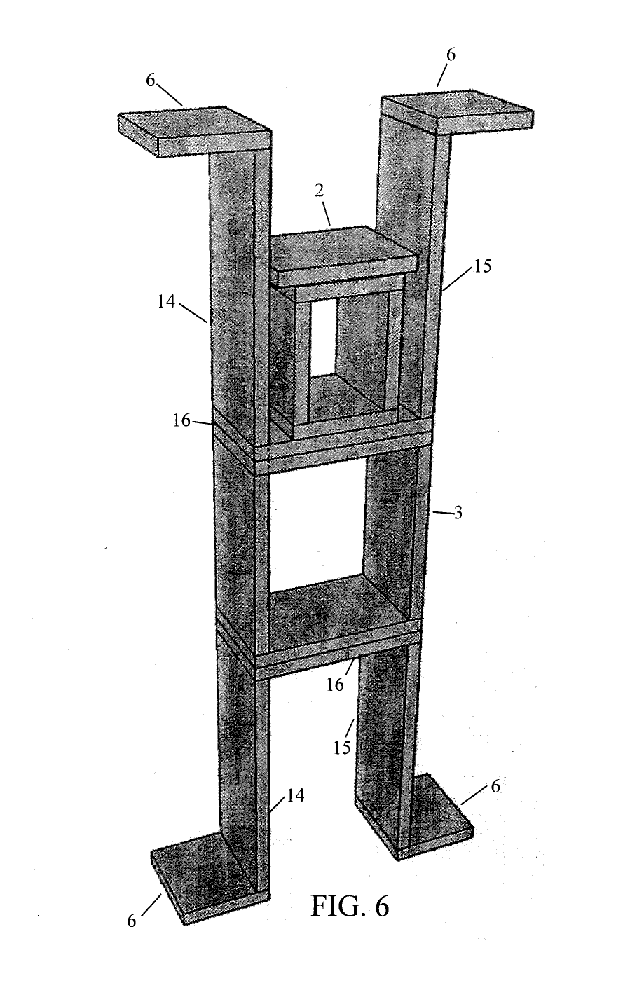

FIG. 6 provides a variation of FIG. 4 where instead of the angled cuts 51 and 52, the cuts are made in a 90 degree or perpendicular manner and thus result in perpendicular orientations of the components, instead of angled as in FIG. 4.

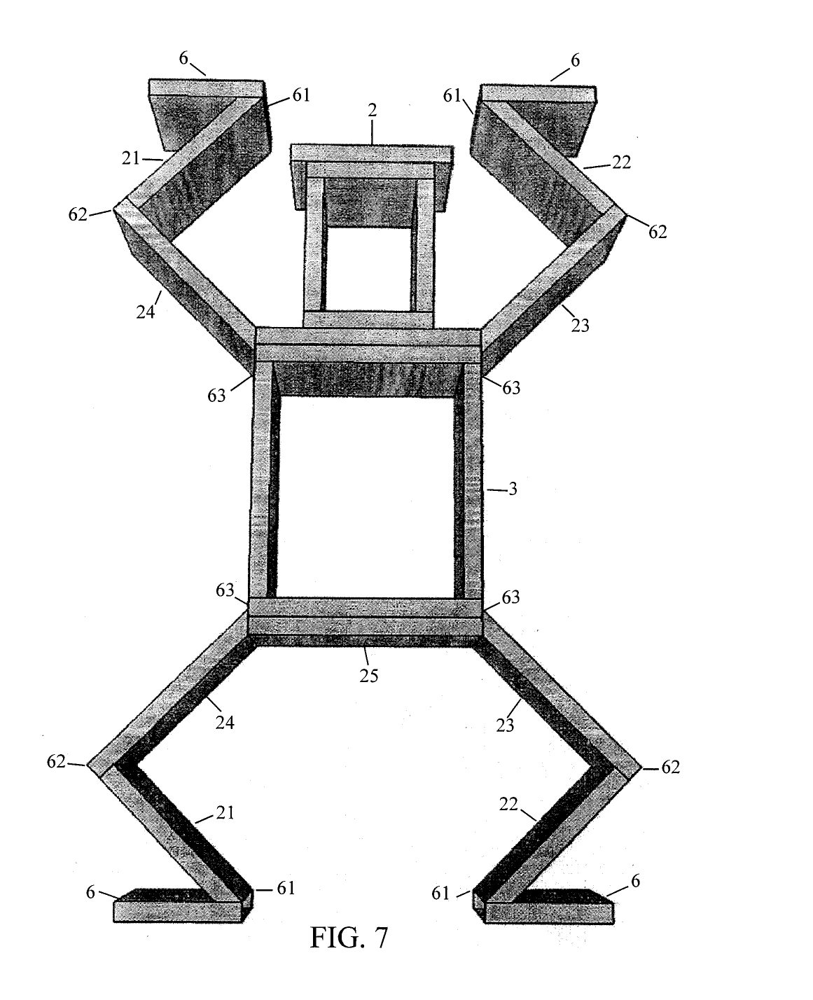

FIG. 7 depicts an embodiment wherein the arms and legs are created out of five component pieces, 21, 22, 23, 24, and 25. While the arms and legs are depicted in the same orientation, the configuration of the arms or legs can be different on each side of the body or different between the arms or legs. Simply put, the user can decide what orientation they like and make the modular shelving system in that mold.

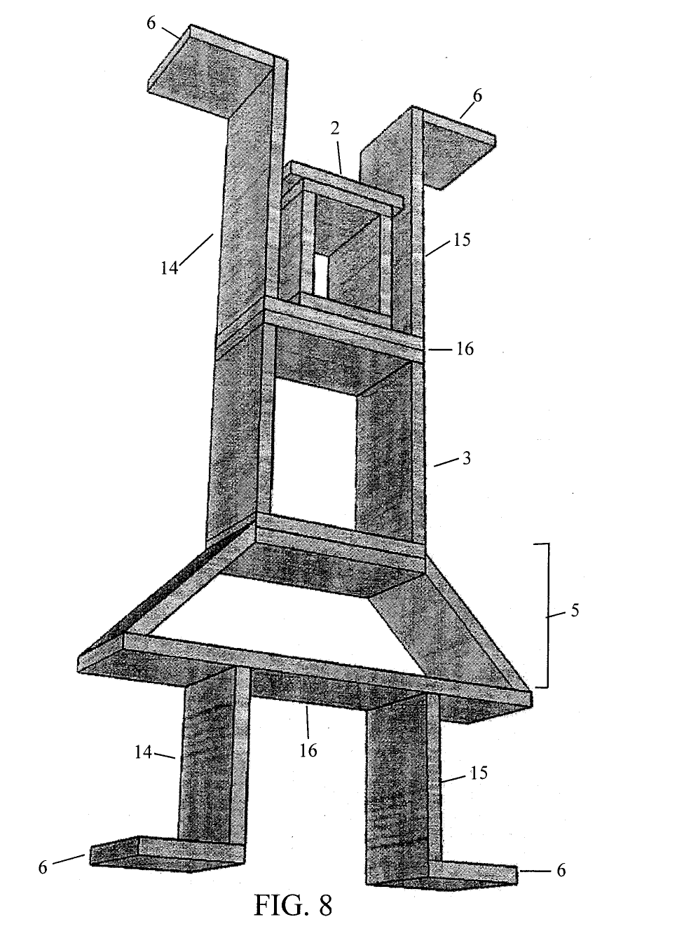

FIG. 8 depicts the use of the skirt 5 feature. The skirt 5 feature can be combined with any other of the components and used as desired. Simply, the skirt 5 feature comprises three elements 80, 81, and 82 having a central component and two side components angled down. The leg features can then be attached in any number of orientations as can be imagined by the user.

Furthermore, methods of manufacturing the endless possible variations of these robot shelves can be done by using a computer program that would generate a unique robot modular shelf design based on customer's personal selection from any combination of Right Arm, Left Arm, Right Leg, and Left Leg added to the standard torso and head shape. Within each modular design there will be at least five shape options to choose from for the arms and legs.

Accordingly, the method comprises a computer implemented program wherein a user can select shapes for a right arm, a left arm, a right leg, and a left leg, and position a torso, a head, and/or a skirt. After selection, the configuration may be partially pre-assembled to secure certain angles on the legs and arms, for example, so as to allow easy assembly of the robotic shelf system by an end user.

The shelf system, therefore, comprises a set of standard shapes, each of the standard shapes comprising themselves a set of standard sized and shaped elements. For example, the standard head 2 comprises five elements, four sides 71-74 to make a rectangular shape and a single hat element 75 that is further attached to one of the sides. Similarly, the body 3 comprises four sides 76-79 to make a quadrilateral shaped body. Indeed, both the head and body can be square, rectangular, trapezoidal, or other quadrilateral shape, if so desired.

In a preferred embodiment, a kit comprising the modular humanoid shelving system comprises 23 total elements that are able to configure together with further standard attachment means. The elements include five head elements 71-75, four body elements 76-79, four hands/feet 6 elements, and 10 arm/leg components (two pairs of 21-25). Together this set of features can be combined to make many different humanoid shelving systems as depicted in the various figures and as can be further generated by ordinary users.

It is further envisioned that a modular system can be defined to define a dog form or a cat form, such that the head, body, arms, legs, may also include tail or ear elements. A simple addition of a pair of ears, which can be secured to a head 2 element can add an animalistic feature to the system. Furthermore, a tail element added to a body 3 element can further define an animal.

It is a particular feature that more than one modular system can be combined together to create a design comprising elements from two or more modular systems.

The materials, methods, and figures presented herein are intended to be illustrative, and not to be construed as limiting the scope or content of the invention. Unless otherwise defined, all technical and scientific terms are intended to have their art-recognized meanings and all other terms, unless defined, are to have their meanings as used by one of ordinary skill in the art.

What is claimed is:

1. A modular shelf system comprising a head, a body, an arm element, a leg element, two hand elements, and two foot elements, wherein said arm and leg components can be configured to and secured to the head and body elements, and said hand and foot elements configured to said arm and leg elements wherein said system defines a modular system having a humanoid form.

2. The modular shelf system of claim 1 wherein said head element comprises five components, a top, two sides, and a bottom, and a hat element, being slightly longer than the top element, and secured to the top element, wherein the features create an open quadrilateral shaped feature; wherein said body element comprises four components, a top, two sides, and a bottom that are arranged to create a quadrilateral shaped feature that has dimensions larger than the head element.

3. The modular shelf system of claim 1 further comprising a skirt element.

4. The modular shelf system of claim 1 wherein the arm and leg components are made up of two equal length components.

5. The modular shelf system of claim 1 wherein the arm and leg components are made up of three components.

6. The modular shelf system of claim 1 wherein the arm and leg components are made up of four components.

7. The modular shelf system of claim 1 wherein the arm and leg components are made up of five components.

8. The shelf system of claim 7 wherein the five components are equal length.

9. A modular shelf system comprising 23 elements, comprising five head elements, four torso elements, five arm elements, five leg elements, and four equal hand/foot elements; wherein said head elements are arranged in a generally rectangular shape using four of the elements and the fifth element being attached to one side of the rectangular shape; wherein the four torso elements are arranged in a generally rectangular shape, and wherein said arm and leg elements can be arranged in any number of arrangements when attached to said head and torso elements to create a humanoid like shelf system, and wherein each of the four hand or foot elements are attached to at least one arm or leg element.

10. The modular shelf system of claim 9 wherein one head element is in contact with at least one arm element and wherein said same arm element is further in contact with at least one body element; wherein connected to said arm element is at least two additional arm elements; further connected to said body element is at least one leg element, and connected to said leg element is at least two further leg elements.

11. The modular shelf system of claim 9 wherein at least two of the arm elements contain angular edges so as to connect together with another arm element at an angle other an 90 or 180 degrees.

12. The modular shelf system of claim 9 wherein at least two of the leg elements contain angular edges so as to connect together with another leg element at an angle other an 90 or 180 degrees.

13. The modular shelf system of claim 9 wherein the arm elements are five equal length elements.

14. The modular shelf system of claim 9 wherein the leg elements are five equal length elements.

15. A method of selecting a modular shelf system comprising:
a. a computer implemented medium comprising a display and tool mechanism for selecting elements;
b. displaying a selection of head, body, arm, leg, hand and foot elements;
c. selecting a head element, a body element, five arm elements, five leg elements, two hand elements, and two feet elements;
d. organizing said elements wherein each of said elements are secured to at least one other element;
e. saving the organization of said elements through said computer implemented medium; and
f. paying for said modular shelf system having said selected and organized elements.

16. The method of claim 10, wherein a further step f includes wherein said selected elements as arranged in step c, are manufactured and secured together with securing means.
